(19) United States
(12) Patent Application Publication
(10) Pub. No.: US 2013/0268378 A1
(43) Pub. Date: Oct. 10, 2013

(54) TRANSACTION VALIDATION BETWEEN A MOBILE COMMUNICATION DEVICE AND A TERMINAL USING LOCATION DATA

(71) Applicant: John Yovin, Woodinville, WA (US)

(72) Inventor: John Yovin, Woodinville, WA (US)

(73) Assignee: Microsoft Corporation, Redmond, WA (US)

(21) Appl. No.: 13/441,090

(22) Filed: Apr. 6, 2012

(51) Int. Cl. G06Q 20/40; H04B 5/00; G06Q 20/32; G06Q 20/20

(52) U.S. Cl. 705/18; 705/44

(57) ABSTRACT

A method and apparatus is provided for performing a transaction involving a mobile communication device. The method includes receiving at a terminal a transaction request from the mobile communication device over a short-range communication link. An authorization request is sent to an authorizing agent requesting approval to complete the transaction in response to receipt of the transaction request. Approval to complete the transaction is received if the mobile communication device has been determined to be located within a predetermined distance of the terminal. The transaction with the mobile communication device is only completed after receiving the approval.

### BACKGROUND

Although there are various solutions that allow for a mobile phone to be used as a payment device, mobile payments and mobile commerce (“m-commerce”) have not been adopted on a wide scale. Various markets, including the United States, are gearing up for the wide-scale deployment and use of this payment media. Specifically, the financial industry, including banks and issuers of credit cards, are building and deploying infrastructure and services to accommodate for expected growth projections.

Payment transaction processing, like other electronic data processing platforms are prone to significant fraud. Such fraud can wreak havoc on the operators and users of such platforms, often compromising private/confidential information and promoting a lack of confidence by the users whose transaction fees support the platform. Additionally, such fraud is costly as cooperating parties (e.g., banks, card issuers, etc.) are left paying the bill (e.g., through fraud protection insurance policies) when fraudulent transactions occur. Although, there are various fraud detection mechanisms in place, such mechanisms may lack reliability and application for m-commerce type payment transactions.

### SUMMARY

A method and apparatus is provided to enhance security when a transaction such as an electronic payment transaction is performed between a mobile communication device and a terminal such as a point-of-sale terminal. One type of fraud that may be detected and avoided by this approach occurs when financial account information is cloned or otherwise obtained from a legitimate user's mobile communication device and installed on another mobile communication device and subsequently used to perform a fraudulent payment transaction, by in effect posing as the mobile communication device of the legitimate user. This type of fraud can be detected by comparing the location of the legitimate user's mobile communication device at the time of the transaction to the location of the terminal. A fraudulent transaction may be being attempted if the mobile device is not found to be in the vicinity of the terminal involved in the transaction.

In one implementation, the location of the mobile communication device is obtained by a party such as a bank or a credit card company who authorizes or otherwise approves the transaction before its completion. In one particular implementation the authorizing party obtains the location of the mobile device from a location tracking service with which the user of the mobile device has pre-registered. The location tracking service periodically receives location information from the mobile device. The nature of the location information will depend in part on the capabilities of the mobile device. For instance, by way of example, the location information may be GPS data obtained from a GPS-equipped mobile device or, alternatively, a beacon ID obtained from an access point with which the mobile device is in communication.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a system that facilitates securing a digital payment between a point-of-sale (POS) terminal and a mobile communication device.

FIG. 2 shows one example of a system that facilitates securing a digital payment between a point-of-sale (POS) terminal and a mobile communication device.

FIG. 3 shows one example of the architecture of the major functional components of a mobile communications device such as depicted in FIG. 1.

FIG. 4 shows an exemplary environment for implementing various aspects of the claimed subject matter.

FIG. 5 is a flowchart showing one example of a method for validating a transaction being performed by a mobile communication device.

### DETAILED DESCRIPTION

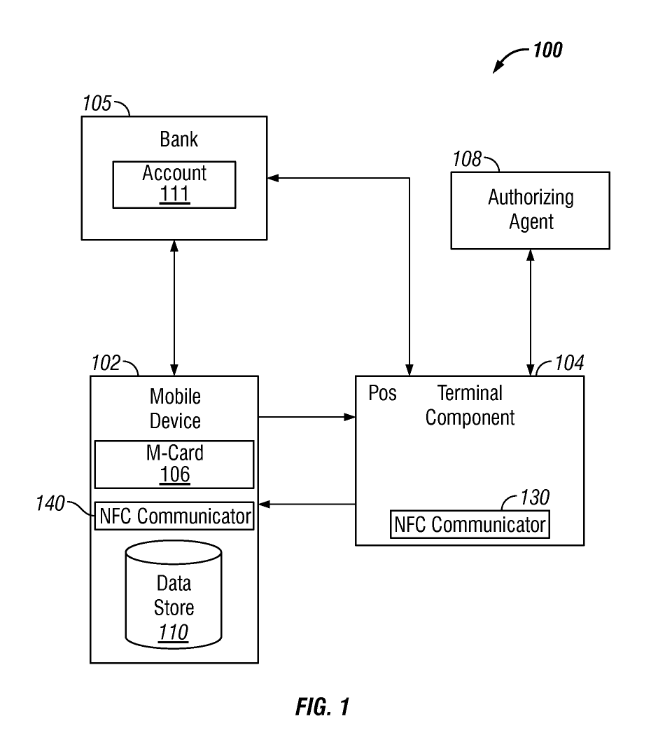

Now turning to the figures, FIG. 1 illustrates a system 100 that facilitates securing a digital payment between a point-of-sale (POS) terminal and a mobile communication device. The system 100 includes a mobile communication device 102 having at least one mobile payment card (herein referred to as the m-card 106). The m-card 106 can be linked to an account 111, wherein the account 111 can include any suitable type or form of currency. For example, the account 111 can include cash, credit, a micro-payment, a pre-paid card, a stored value card, a disposable card, a line of credit, an exchange of a service, an exchange of a good, or a tab. Moreover, it is to be appreciated that the account 111 can be related to a checking account, a savings account, an investment account, a bond, a certificate of deposit (CD), and/or any other suitable account related to monetary value.

The mobile communication device 102 can be any suitable device that can include the m-card 106 and communicate wirelessly with the POS terminal 104. Illustrative examples of a mobile communication device include, but are not limited to, a handheld, a portable digital assistant, a cellular device, a mobile communication device, a portable media player, a gaming device, a pocket PC, a smartphone, etc. In general, the mobile communication device 102 can utilize the m-card 106 for wireless transactions with the POS terminal 104, generally in a secure manner using, for example, public-key cryptography (PKC). The m-card 106 may include account information, passwords, personal identification numbers (PINs), personal information, account numbers, routing numbers, and/or any other portion of data related to an account 111. Thus, the mobile communication device 102 can incorporate at least one m-card 106 that can be utilized to execute or provide payment for a wireless transaction with the POS terminal 104.

As depicted, the account 111 can be maintained or otherwise provided by a bank 105. However, it is to be appreciated that any suitable third-party or financial institution can be connected to the m-card 106 and/or the account 111 such as, but not limited to, a credit card company, a business that issues credit, an online bank, a brick-and-mortar bank, etc. Furthermore, the system 200 can be utilized with credit card-like (CC) transactions, debit cards, prepaid cards, and/or any other suitable digital equivalents thereof. The system 200 can also be used in scenarios that do not involve a payment but involve the transfer of any type of secure information. Examples of such information may include information concerning a keycard security entry and a loyalty card, for instance. The mobile communication device 102 can hold a number of m-cards (e.g., m-card 106), each of which can be issued by a respective bank (e.g., the bank 105).

Upon attempting to conduct a transaction with the mobile communication device, the POS terminal 104 issues a transaction request, which is sent to an authorizing agent 108 (directly from the POS terminal 104 or indirectly such as through middleware, a frontend switch, gateway, processor, payment network, or a backend switch). The authorizing agent 108 performs such functions as authenticating the transaction, seeking payment authorization through a TPPN (third party payment network or gateway provider for mobile payment system services) and sending a response (approval or related error code such as insufficient funds) to the POS terminal. The POS terminal 104 only completes the transaction if the authorizing agent approves the transaction.

The data associated with a digital payment transaction (e.g., m-cards, transactional data, account information, user preferences, payment history data, wireless settings, certificates, time stamps for validation, and/or any other suitable data associated with the system 100) can be stored in a data store 210 of the mobile device. In general, the data store 210 can include any suitable data related to the mobile communication device 102, the terminal component 104, the m-card 106, the account 111, the bank 105, the certifying authority 208, the certificate 204, etc.

It is to be appreciated that the data store 110 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory.

Communication between the mobile communication device 102 and the POS terminal 104 may be established over a short range wireless technology such as Near-Field Communication (NFC), for example. NFC technology involves two NFC-enabled devices being brought together in close proximity to transfer information. Positioning the devices in close proximity provides an added benefit of increased security. NFC can be used with a variety of devices, including mobile phones and/or other portable electronic devices transferring information. NFC operates using magnetic field induction at a frequency of, for example, 13.56 MHz and transferring data at up to 424 Kbits/second. NFC provides both read and write exchange of data between electronic devices.

Communication between two NFC-compatible devices occurs when the devices are positioned, for example, within about four centimeters of one another. As an example, a motion or touch by a user with an NFC-equipped communication device can establish an NFC connection. The connection can be compatible with other known wireless technologies, such as Bluetooth or Wi-Fi. NFC communication technology operates according to accepted standards, such as International Standards Organization (ISO) and/or other telecommunications standards, including, for instance, ISO/IEC 18092, ISO/IEC 14443, ISO/IEC 15693 and ISO/IEC 21481.

In system 100, POS terminal 104 is equipped with an NFC communicator 130, which reads and captures the data used to submit and gain transaction authorization and approval for the transaction from the authorizing agent 108. Mobile communication device 102 is likewise equipped with an NFC communicator 140 for providing the data to the NFC communicator 130.

In general, NFC communicators are capable of both initiating a near field communication (through transmission or generation of an alternating magnetic field) with another NFC communicator and of responding to initiation of near field communication by another NFC communicator. An NFC communicator may operate in a “reader” or “initiator” mode in which the NFC communicator seeks to initiate near field communication or in a “tag” or “target” mode in which the NFC communicator is receptive to initiation of near field RF communication. An initiator NFC communicator will generate an RF field and a target NFC communicator will respond by modulation of the received field, usually by load modulation. Consequently NFC communicators 130 and 140 both do not need to serve as an NFC reader and target. For instance, NFC communicator 130 may be an NFC reader while NFC communicator 140 may be an NFC target (or visa versa).

Of course, other short-range communication technologies such as Bluetooth or RFID may be employed to establish communication between the mobile communication device 102 and the POS terminal 104. For purposes of illustration only the short-range communication technology will be referred to in what follows as employing an NFC protocol, which is now available on a growing number of wireless communication devices.

As previously mentioned, security remains a significant concern when performing an electronic payment transaction between a mobile communication device and a merchant because financial data is communicated between the mobile communication device and the point of sale. When the financial data is transmitted wirelessly, such as when NFC technology is employed, the risk increases because it may be possible to intercept and clone in-transit data, which may then be used for improper purposes such as to fraudulently purchase goods or services. When used to fraudulently perform other types of transactions, it may allow access to a secure entrance or bypass other NFC secured activities.

If the financial transaction data is cloned or otherwise obtained from a legitimate user's mobile communication device, installed on another mobile communication device and used at a merchant location, the mobile communication device can be used to perform a fraudulent payment transaction by in effect posing as the mobile communication device of the legitimate user. One way to address this problem is to check the location of the legitimate user's mobile communication device at the time of the transaction. If it is found that it is not in the vicinity of the merchant location, then the merchant has reason to suspect that a fraudulent transaction may be being attempted. At this point the merchant can take any appropriate action such as denying the transaction, requesting additional identification information and so on.

The location of a mobile communication device at any given time can be made available when a payment transaction is requested because many mobile communication devices already include the capability to track their location. Location-aware mobile communication devices include a device location module that enables the mobile communication device to determine its own geographic location. In one implementation, the device location module is a GPS receiver, which is capable of updating a device's location on a real or near real-time basis.

A GPS receiver receives signals from orbiting satellites that are used as references. The receivers measure the time it takes for the signals to reach the receiver. After receiving the signals from three or more GPS satellites, the receiver can triangulate its position on the globe. The location is typically represented in terms of the physical coordinates of the mobile communication device 102 on the surface of the Earth, typically using as latitude and longitude values. The GPS receiver can also employ other geo-positioning mechanisms, including, but not limited to, triangulation, assisted GPS (AGPS), E-OTD, CI, SAI, ETA, BSS or the like, to further determine the physical location of the mobile communication device 102 on the surface of the Earth. In addition to, or as an alternative to GPS, the location-aware mobile communication device may employ other positioning technologies such as cell tower triangulation and Wi-Fi location systems, for example.

Location-aware mobile communication devices which include a device location module using a Wi-Fi location system extract a beacon ID from the beacons which are periodically sent by Wi-Fi access points. The mobile communication device transmits the beacon IDs to a server which may access a look-up table or the like in a database to find the corresponding location of the access point or other signal source represented by the beacon ID. The server may then transmit the access point location back to the mobile communication device. In turn, the location of the mobile communication device may be determined as being within the coverage area of the access point. When the mobile communication device changes location so that it begins to communicate with a different access point, the received beacon signal may change accordingly. The new beacon signal may include a new beacon ID, which can be sent to the server so that the location of the access point identified by the new beacon ID can be resolved. In this way the mobile communication devices may determine its location as being within the coverage area of the new access point.

Various services are currently available which provide location information to mobile communication devices using one or more of the aforementioned techniques. Systems such as those described in FIG. 1, which facilitates digital payment transactions between POS terminals and mobile communication devices can leverage the location information available from such location services to determine the location of a mobile communication device involved in a transaction.

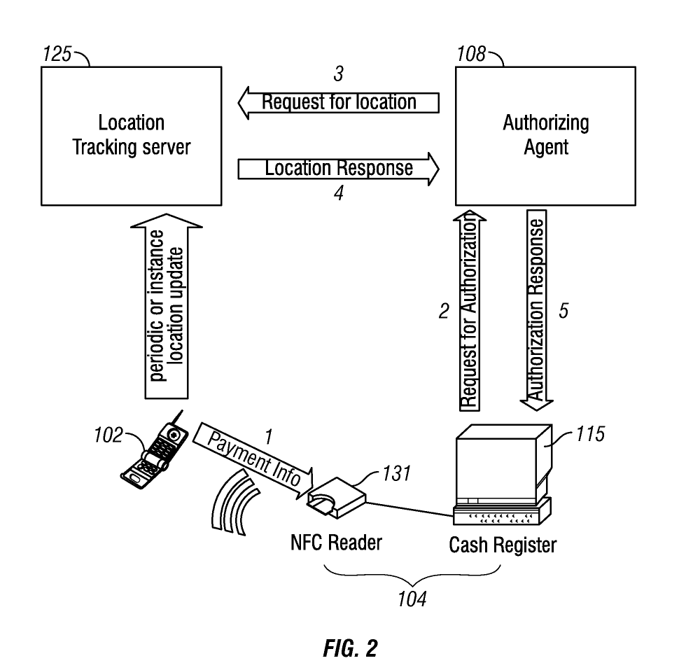

FIG. 2 shows one example of a system that facilitates securing a digital payment between a point-of-sale (POS) terminal and a mobile communication device in which the POS terminal confirms the location of the mobile communication device as a part of the transaction process. In FIGS. 1 and 2, as well as the figures that follow, like elements are denoted by like reference numerals. FIG. 2 shows mobile communication device 102 (configured as a mobile phone in this example), a POS terminal 104 that is illustrated as a cash register 115 equipped with an NFC reader 131, and authorizing agent 108. FIG. 2 also shows a location tracking server 125 for tracking the location of the mobile communication device 102 and to provide location information to one or more parties (e.g., authorizing agent 108) authorized to request and receive such information. The location tracking server 125 may be part of a commercially available service that tracks such location information for use by various location-based applications hosted by the mobile communication device 102. Mobile device users will generally have pre-registered with such services. Alternatively, the location tracking server 125 may be dedicated to the provisioning of location information for the purpose of confirming the location of the mobile communication device as a part of the payment transaction process. In the latter case the location tracking service may be affiliated with the authorizing agent 108. In the former case the location tracking service may have a pre-established contractual relationship with the authorizing agent 108 as well as the user of the mobile device 102.

Regardless of the precise legal and/or contractual relationship between the location tracking service, the authorizing agent as well as the user of the mobile communication device, it should be noted that user information and location information is only collected and stored after notice has been provided to the user that the collection of personal information may occur, for example, when signing up to use the location-tracking service and the payment transaction service. The notice will also indicate that this information will not be shared with third parties, other than as may be needed to maintain or enhance the quality of the service that is being provided. Other policies that are intended to protect the user's privacy and enhance the quality of the user experience may also be employed. Once the user is informed as to the terms of service, the user will be given an opportunity to consent to the terms of service.

FIG. 2 also shows a sequence of messages that may be communicated between and among the various devices and systems involved in the transaction. In general the sequence, content and other details concerning these messages may vary, including whether the messages are communicated in response to a push or a pull. However, a typical sequence of messages may proceed as follows. First, at 1, the transaction begins when the NFC reader 131 at the POS terminal 104 reads account information from the mobile communication device 102 over, e.g., an NFC communication link. At 2, the POS terminal (in this example cash register 115) sends an authorization request message to the authorizing agent 108 as part of its validation process to ensure that the transaction is authorized by the appropriate parties (including, e.g., bank 105). In addition to performing its normal validation process, the authorizing agent sends a request to the location tracking server 125 at 3 identifying the mobile communication device 102 and either requesting the current location of the mobile communication device 102 or requesting the service to confirm that the mobile communication device 102 is within a reasonable distance of the POS terminal 104. In the latter case the authorizing agent 108 will also provide the location tracking server 125 with the identification and/or the physical location of the POS terminal 104. The location tracking service may obtain the location information directly from the mobile communication device or from an access point (e.g., a cell tower) with which the mobile communication device is or recently has been in communication. In the latter case the location tracking service may be the wireless service provider itself, which may have a contractual relationship with the authorizing agent in order to provide such information.

The communication of messages between the authorizing agent 108 and the location tracking server 125 may in part depend on the relationship between them. For instance, if they are both provided by the same party, then in some cases they may communicate over a common private enterprise network such as a private local area network (LAN) or a private wide area network (WAN). Alternatively, if the location tracking services and the services of the authorizing agent are provided by independent parties, they may establish a secure communication link over a public network such as the Internet. In any case, details concerning the manner in which the various parties involved in the transaction validation process communicate with each other are not pertinent to the present discussion and therefore will not be elaborated upon further.

Returning to FIG. 2, after the location tracking service sends the location response to the authorizing agent at 4, the authorizing agent 108 determines if the transaction is to be approved. As part of its analysis the authorizing agent determines if the mobile communication device 102 is sufficiently close to the POS terminal 104 to conclude that the account information has in fact been provided by the proper (e.g., registered) mobile communication device. The mobile device's proximity to the POS terminal 104 beyond which the transaction may be denied will depend in part on a number of factors including, for instance, the accuracy with which the location tracking service can locate the mobile device (which in turn depends in part of the location tracking technology that is used), the frequency with which the service receives location updates and the technology used to established communication between the POS terminal 104 and the mobile device 102 (which determines how close the two devices need to be to one another to communicate information).

If the mobile communication device 102 is sufficiently close and all other conditions are satisfied, then the authorizing agent 108 approves the transaction and communicates its authorization to the POS terminal 104 at 5. If the mobile communication device 102 is not sufficiently close to the POS terminal 104, then the message sent to the POS terminal declines approval of the transaction or requests that additional steps be taken before its approval is given. Among the other actions that may be taken if the mobile communication device 102 is determined not to be sufficiently close to the POS terminal 104, a message may be sent from the authorizing agent to the account holder advising the account holder of a potential security breach.

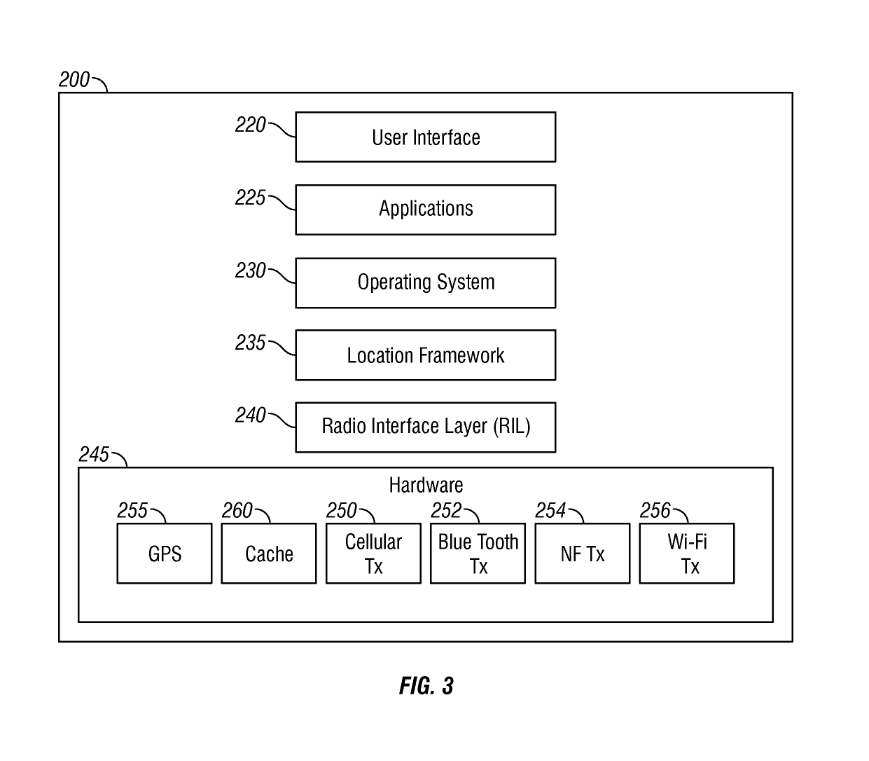

FIG. 3 shows one particular illustrative architecture 200 of the major functional components of a mobile communications device such as depicted in FIG. 1. Although the architecture 200 shown in FIG. 3 is particularly adapted for a mobile phone, the principles it illustrates can be expected to have general applicability to other platforms such as, for example, a laptop PC, a netbook, a tablet or the like. In this exemplary embodiment, a UI 220 is provided by the architecture 200 to support user interactivity and facilitate an effective user experience, and will typically be embodied as a graphical user interface. A variety of applications reside on the mobile communication device, which applications are collectively indicated by reference number 225. Some applications that reside on the mobile communication device may offer location-based services which may require the mobile communication device to determine its location as well as a history of locations previously visited. Other applications may facilitate mobile commerce and allow the mobile device to function as a so-called electronic wallet. Non-exhaustive examples of applications that may reside on the mobile device include map applications, traffic alert applications, geo-tagging applications (to e.g., tag a recorded image with its location) and other applications that identify for the user nearby points-of-interest (e.g. restaurants, stores).

Supporting the applications 225 in the architecture 200 are an operating system 230, a location framework layer 235, a radio interface (RIL) layer 240 and a hardware layer 245. In this exemplary embodiment, the operating system 230 is particularly adapted to operate on a resource-limited device and may comprise, for example, a mobile operating system. The location framework layer 235 provides logic and control functions that capture the location information obtained from the hardware layer 245 and makes it available to any of the applications 225 that are to use it. The RIL layer 240 is a set of APIs providing a level of abstraction between the radio on a mobile phone and the software of the mobile phone. That is, the RIL layer 240 serves as a hardware adaptation layer, i.e., a layer that isolates the specifics of a particular mobile system/hardware from the bulk of the software system. In this way various software solutions may be adaptable to multiple different mobile systems and radios.

The hardware layer 245 provides an abstraction of the physical hardware implemented on the mobile communication device and will typically include a processor (e.g., a central processor or “CPU”), system memory such as read only memory (“ROM”) and random accessory memory (“RAM”), bus structures, peripheral systems, drives, display devices, user controls and interfaces, etc. The hardware may also include storage media for storing computer-executable instructions (i.e., code) including either or both removable media and non-removable media such as magnetic and optical media, solid-state memory, and other conventional media. The aforementioned physical hardware components are not illustrated in layer 245 since they are not pertinent to the present discussion. However, the following hardware components are depicted in FIG. 3 since they are pertinent to the discussion that follows.

In particular, the hardware layer 245 of the mobile communication device includes one or more wireless transceivers. In this implementation mobile communication device 200 includes a cellular radio transceiver 250, a Bluetooth transceiver 252, and NFC transceiver 254 and a Wi-Fi transceiver 256. The mobile communication device 200 also includes a GPS receiver 255 and a cache 260. The wireless transceivers allow the mobile communication device to communicate over wireless networks. The cellular radio transceiver 250 includes such conventional components as a transmitter, receiver, antenna and so on. The GPS receiver 255 receives signals through a GPS antenna from a GPS satellite navigation system for determining the location of the mobile communication device. Among other things, the cache 260 may be used to store cellular base station IDs (BSIDs) and their corresponding location information pertaining to various cellular base stations that the mobile communication device has been in communication with. As previously mentioned, location information may be determined using data obtained from the GPS receiver 255 and/or any of the aforementioned transceivers.

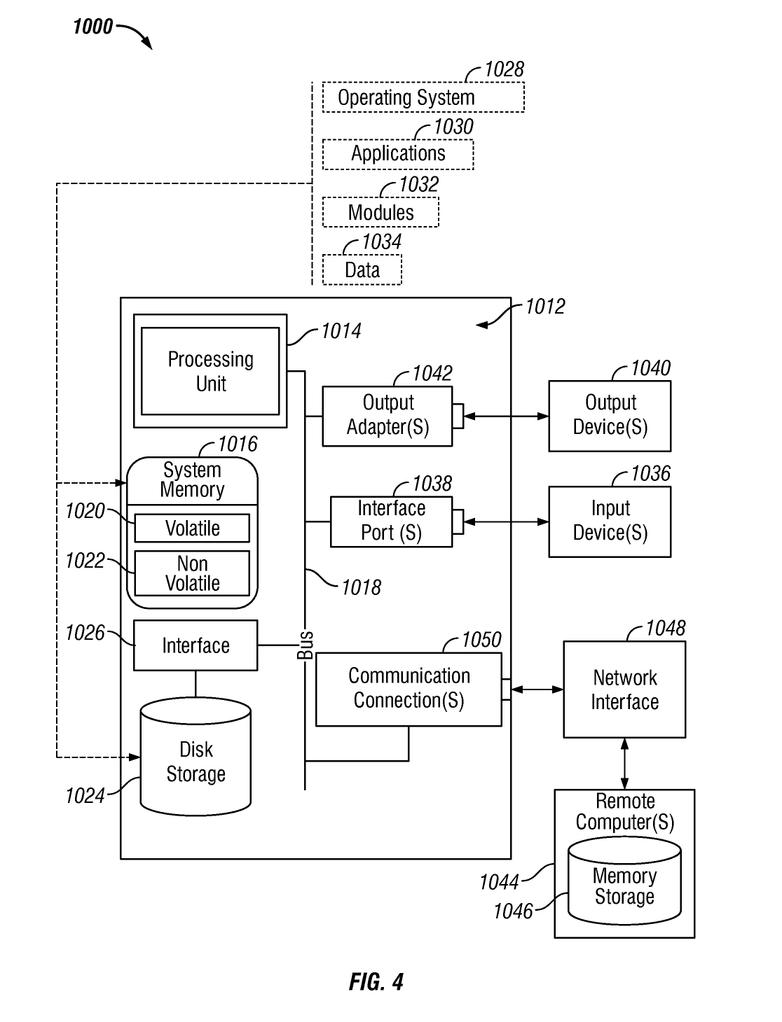

With reference to FIG. 4, an exemplary environment 1000 for implementing various aspects of the claimed subject matter includes a computer 1012. In some cases computer 1012 may function as a client or as a server. For instance, computer 1012 may correspond to the POS terminal 104 of FIG. 2. The computer 1012 includes a processor 1014, a system memory 1016, and a system bus 1018. The system bus 1018 couples system components including, but not limited to, the system memory 1016 to the processor 1014. The processor 1014 can be any of various available processors. Dual microprocessors and other multiprocessor architectures also can be employed as the processor 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer-readable storage media. FIG. 10 illustrates, for example a disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software will generally apply processing logic and rules to implement the desired behavior. Application of the processing logic and rules will typically implement a variety of routines, processes, and workflows to support the user experiences described above.

The software may include an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 may include, but are not limited to, a pointing device such as a mouse, trackball, stylus, touch pad (with or without gesture control), keyboard, microphone, joystick, game pad, satellite dish, scanner, TV tuner card, digital camera, digital video camera, web camera, and the like. Additionally, in some implementations voice-activated input devices may be employed. These and other input devices connect to the processor 1014 through the system bus 1018 via interface port(s) 1038.

Interface port(s) 1038 may include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which may use special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. If computer 1012 corresponds to the POS terminal 104 of FIG. 2, for instance, then remote computer 1044 may correspond to the authorizing agent 108 (or visa versa) of FIG. 2. For purposes of brevity, only a memory storage device 1046 is illustrated with remote computer(s) 1044. Remote computer(s) 1044 is logically connected to computer 1012 through a network interface 1048 and then physically connected via communication connection 1050.

Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software used for connection to the network interface 1048 includes, for exemplary purposes only, internal and external technologies such as, modems including regular telephone grade modems, cable modems and DSL modems, ISDN adapters, and Ethernet cards.

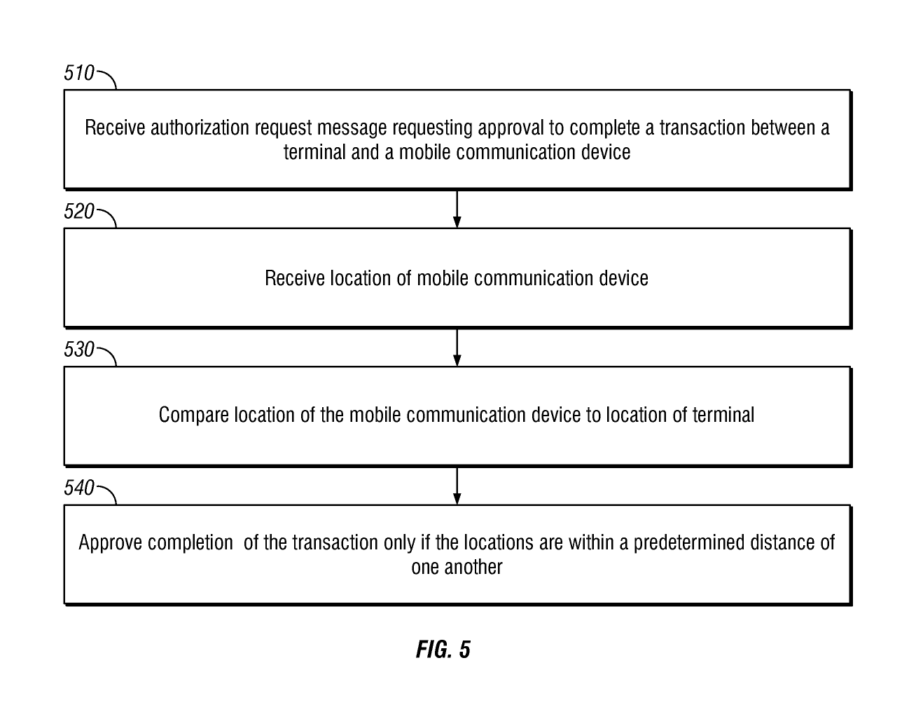

FIG. 5 is a flowchart showing one example of a method for validating a transaction being performed by a mobile communication device. The method begins at step 510 when an authorization request message is received. The authorization request message requests approval to complete a transaction between a terminal and a mobile communication device. The location of the mobile communication device is received in step 520. The location of the mobile communication device is compared to the location of the terminal in step 530. Completion of the transaction is only approved in step 540 if the location of the mobile communication device is within a predetermined distance of the location of the terminal. In some implementations the aforementioned steps may be performed by an authorization agent such as the authorization agent 108 shown in FIG. 2.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

There are multiple ways of implementing the present innovation, e.g., an appropriate API, tool kit, driver code, operating system, control, standalone or downloadable software object, etc. which enables applications and services to use the techniques of the subject innovation. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

Moreover, as used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

1. A method for performing a transaction involving a mobile communication device, comprising:
receiving at a terminal a transaction request from the mobile communication device over a short-range communication link;
sending an authorization request to an authorizing agent requesting approval to complete the transaction in response to receipt of the transaction request;
receiving approval to complete the transaction if the mobile communication device has been determined to be located within a predetermined distance of the terminal;
completing the transaction with the mobile communication device after receiving the approval.

2. The method of claim 1 further comprising requesting additional credentials from a user of the mobile communication device before completing the transaction if the mobile communication device is not within the predetermined distance of the terminal.

3. The method of claim 1 in which the terminal is a Point-of-Sale (POS) terminal and the transaction is a transaction for payment through the mobile communication device for a good or service.

4. The method of claim 3 in which the mobile communication device maintains a mobile payment card storing account information for completing the payment transaction.

5. The method of claim 1 further comprising requesting issuing a warning if the mobile communication device is not within the predetermined distance of the terminal.

6. The method of claim 5 in which the short-range communication link is a Near-Field Communication (NFC) link.

7. A method for validating a transaction being performed by a mobile communication device, comprising:
receiving an authorization request requesting approval to complete a transaction between a terminal and a mobile communication device;
receiving the location of the mobile communication device;
comparing the location of the mobile communication device to a location of the terminal; and
approving completion of the transaction only if the location of the mobile communication device is within a predetermined distance of the location of the terminal.

8. The method of claim 7 in which the location of the mobile device is received as a result of a push or a pull.

9. The method of claim 7 further comprising sending a request to identify a location of the mobile communication device in response to receipt of the authorization request.

10. The method of claim 7 further comprising requesting additional credentials from a user of the mobile communication device before completing the transaction if the mobile communication device is not within the predetermined distance of the terminal.

11. The method of claim 7 in which the authorization request is received from a POS terminal that is attempting to complete the transaction with the mobile device.

12. The method of claim 7 in which the POS terminal communicates with the mobile device over a short range-wireless communication

13. The method of claim 7 in which the location of the mobile communication device is obtained from a device location module with which the mobile communication device is equipped.

14. The method of claim 13 further comprising receiving the location of the mobile communication device from a location service with which the mobile communication device has pre-registered.

15. The method of claim 9 further comprising sending the request to identify the location of the device to a location tracking service and receiving from the location tracking service a last known location of the mobile device.

16. The method of claim 15 in which the location tracking service obtains the last known location of the mobile device from a device location module with which the mobile communication device is equipped.

17. The method of claim 16 in which the device location module is a GPS module.

18. A system for performing a transaction based on account information received from a mobile communication device, comprising:
a reader module for obtaining account information from the mobile communication device over a short-range communication link;
a network interface for communicating with third parties over a communication network;
one or more processors for executing machine-executable instructions; and
one or more machine-readable storage media for storing the machine-executable instructions, the instructions when executed by the one more processors implementing,
processing logic configured, in response to receipt of a transaction request received by the reader module, to (1) send, via the network interface, an authorization request to an authorizing agent requesting approval to complete the transaction in response to receipt of the transaction request (2) receive approval to complete the transaction if the mobile communication device has been determined to be located within a predetermined distance of the terminal and (3) complete the transaction with the mobile communication device after receiving the approval.

19. The system of claim 18 in which the reader module is an NFC reader and the short-range communication link is an NFC link.

20. The system of claim 18 in which approval to complete the transaction is received over the network interface from an authorization agent in communication with a location tracking service that tracks the location of the mobile communication device.
